(19) United States
(12) Patent Application Publication
(10) Pub. No.: US 2008/0222030 A1
(43) Pub. Date: Sep. 11, 2008

(54) METHOD AND SYSTEM FOR PURCHASING PRODUCTS VIA TEXT MESSAGING

(76) Inventor: Anthony H. Fischler, Santa Monica, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/684,159

(22) Filed: Mar. 9, 2007

(51) Int. Cl. G06Q 40/00; G06Q 30/00

(52) U.S. Cl. 705/39; 705/14

(57) ABSTRACT

A method and system including distributing a keyword, and receiving a text message from a device through a carrier with the keyword to purchase a product. The carrier adds a purchase price of the product to the purchaser's wireless service bill and the product is distributed to the purchaser external to the device.

### BACKGROUND

1. Field

The embodiments relate to purchasing products through text messaging, and in particular to purchase products associated with a keyword and a text message number where a user cellular account is charged for the products.

2. Description of the Related Art

Today purchases are made for items electronically through such mediums as debit cards, credit cards and service companies (e.g., Paypal®). People that want to purchase items on the Internet must have one of these types of mediums. Users that do not have one of these mediums must send personal or bank checks, purchase money orders or use a service, such as Western Union®.

With the wide use of cellular telephone use, some items can be purchased through a cellular telephone. Some of these items are ring-tones and wallpaper specifically for the cellular telephone. These items are paid for through a specific account that is set up for the user to make purchases. Further, to purchase these items, a user typically has to wade through webpages on the cellular telephone to find the specific item. When the user does find the item and selects to purchase the item, the item is downloaded directly to the cellular telephone.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates one embodiment of a system;

FIG. 2 illustrates a method of an embodiment;

FIG. 3 illustrates an embodiment of a screen shot from a website;

FIG. 4 illustrates an embodiment of a client's product webpage;

FIG. 5 illustrates a method of an embodiment;

FIG. 6 illustrates another method of an embodiment; and

FIG. 7 illustrates yet another method of an embodiment.

### DETAILED DESCRIPTION

The Embodiments discussed herein generally relate to a method and system for purchase products associated with a keyword and a text message number where the purchase price is added directly to a customer's cellular telephone bill. Referring to the figures, exemplary embodiments will now be described. The exemplary embodiments are provided to illustrate the embodiments and should not be construed as limiting the scope of the embodiments.

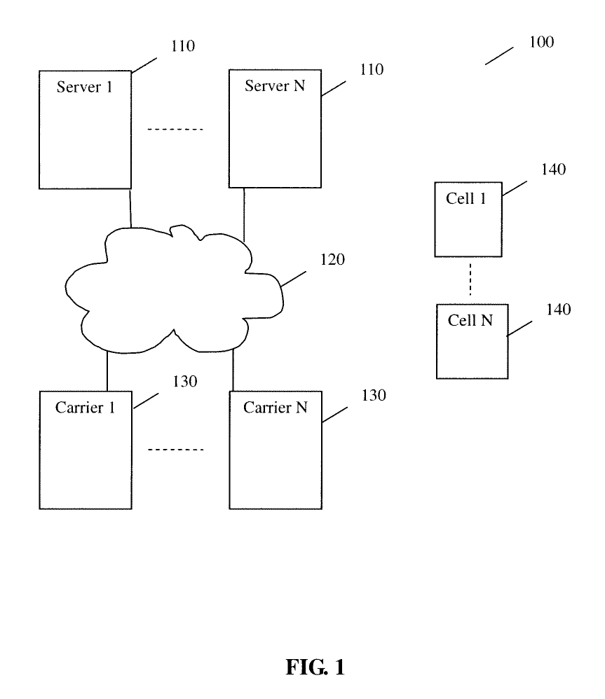

FIG. 1 illustrates one embodiment of a system 100 including a plurality of servers 110, one or more networks 120, a plurality of wireless cellular or wireless service carriers 130 and numerous wireless devices 140. In one embodiment, the servers 110 can be any type of servers providing networked services, such as hosting of websites, relaying information, transmitting/receiving electronic information, etc. In one embodiment, wireless devices 140 can be any type of wireless device that is capable of transmitting/receiving text messages, such as cellular telephones, electronic cameras, personal digital assistants (PDAs), notebook computers, palm held computers, etc.

In one embodiment a user (purchaser) transmits a text message from the wireless device 140 to an assigned number using a specific keyword to purchase a product associated with the specific keyword. The keyword can be distributed on a display, a product, a building, a billboard, a website, announced, flyer, newspaper, catalog, etc. The transmitted text message is received by one of the wireless carriers 130. The one wireless carrier 130 adds the purchase price of the desired product to the purchaser's or customer's regular cellular telephone bill and the product is distributed to the purchaser external to the device. In one embodiment, the purchaser receives a code, password, number, PIN, etc. (hereinafter referred to as code) on the wireless device in a text message and then downloads the product from a website hosted on one of the servers 110 via an external computing device connected to the network 120, including but not limited to cellular phone equipped with web browsers, lap top computers, and desk top computers. In this embodiment, the product is an audio file, a video file, an audio and video file, a text file, entrance to an event or contest, or a photograph.

In one embodiment, one wireless carrier 130 receives a first percentage of the purchase price and transfers remaining funds from the product purchase price to a host of the website offering the product running on a server 110. The host of the website receives a second percentage of the purchase price and transfers remaining funds to the seller of the product. In one example, the seller can be a musical artist offering music videos, albums, songs, photographs, tickets, etc. for sale through the website offering the service of purchasing via text messaging and the purchaser's wireless telephone carrier 130. In one embodiment, the percentages can be wire transferred automatically or transferred with a physical bank check or money order.

In one embodiment the purchaser retrieves the product from a land based business. In this embodiment, the purchaser would travel to the business location or visit the business's Internet website. The purchaser would then transmit the code to the business or service provider and would then physically receive the product. In another embodiment, the business has an offshore location, whether located on a platform, ship, etc. Additionally, the physical product may be shipped by the business to the purchaser and the cost of shipping would be added to the cost which would appear on the cellular phone bill.

In another embodiment the product is an entrance to an event, or any combination of video content, audio content and entrance to the event. In this embodiment, the event can be a concert, a contest, a show, a movie, a performance, a match, a sporting event, etc. In one embodiment, when a purchaser purchases a product, they are automatically entered into a contest.

In one embodiment the product is cash or cash back from the purchase (along with the product). The purchaser can receive the product in various ways. In one embodiment, the purchaser texts the assigned number with a key word assigned to the amount of cash, where the keyword can be a number, a word, any combination of letters and words, etc. The purchaser receives the purchase code and the code is entered into a device, such as an ATM machine, a cash register, a credit/debit device, etc.

In one embodiment the product is a physical product or a service. In this embodiment, the product can be any type of goods or services. For example, a purchaser does not have enough cash or a credit card to purchase lunch or dinner. The purchaser can read a keyword and number on a menu, display, etc., transmit a text message to an assigned number. Once approved, the seller transfers the food to the purchaser. Another example could be taxi service, clothes, medicine, etc. As some people (adults or children) may not have credit or debit cards, using the cell phone bill for making purchases is very convenient.

In one embodiment, the seller adjusts the price when a purchaser uses a wireless device to purchase products. In this embodiment, since the wireless carrier receives a fee (fixed or a percentage of the purchase price), and the server host or owner of the embodiments receives a fee (fixed or a percentage of the purchase price), the seller adds the service fees to the purchase price to maintain their profit level. In another embodiment, the carrier and server host or owner of the embodiments receives a fixed fee for certain sellers that sell a large volume of merchandise using the embodiment.

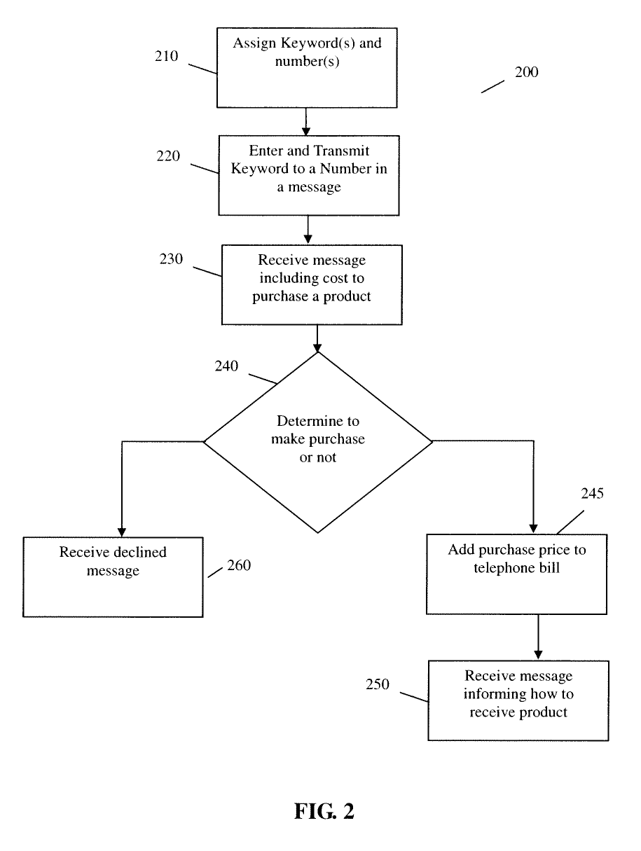

FIG. 2 illustrates a block diagram of a process/method 200. Process 200 begins with block 210 by assigning a code with a product and a number that the user uses to send a text message to. In one embodiment, the code is chosen by a host of a website, either manually or automatically. In one embodiment, the code is stored in a database and linked to a specific product (any goods or services). When the code is automatically assigned, a process determines an available code. In one embodiment, the code is based on a random number generator and hash of the product. In another embodiment, the seller chooses an available code. In this embodiment, a process searches the database after the seller enters the code to see if the code is in use or not. In one embodiment, certain keywords are auctioned off to the highest bidder. In this embodiment, certain sellers preferably want to have “catchy” codes or codes easily remembered. Some purchaser's may prefer buying products with easy to remember codes, such as “hamburger” or “taco” at fast food locations, etc. In another embodiment, sellers can use standard codes and use different numbers for the users to send text messages to.

In one embodiment the distribution of the keyword is announced by a person at an event, displayed on a website, announced on the radio, shown or announced via television, displayed on an advertising medium, printed on a product located at a business and displayed at a business.

In one embodiment a number that the user sends a text message to is used by a website, business, etc. for all the products available for sale on the website. In this embodiment, only the assigned codes are different. The user uses the same number with the code assigned to the specific product the user wishes to purchase. In another embodiment, different numbers are assigned to the different sellers.

In block 220 a user enters a number and code and transmits the text message, which is received from a wireless device (such as device 140) through a cellular carrier (such as carrier 130) to purchase a product. In one embodiment, after the user sends the text message, in block 240 the wireless device receives a text message back informing the user of the purchase price for the product and prompts the user to either accept the purchase or decline the purchase. If the user declines the purchase, process 200 continues with block 260, where the user receives a decline purchase confirmation.

If the user accepts the purchase, in block 245 the carrier 130 adds the purchase price to the device's 140 wireless telephone bill. Process 200 continues with block 250. In block 250 the user receives information on how to receive the product. In one embodiment, the user receives a password or code and enters the password or code via a website to download the product. In another embodiment, the user enters the password or code on a device located at a place of business where the product is being sold. The password or code can either be entered in an electronic device, entered into a cash register, sent wirelessly to a device (e.g., through Bluetooth, text message, email, etc.), etc. In these embodiments, the product does not directly get transferred to the device 140. In one embodiment the code or password is a personal identification number (PIN) that can be used to receive the purchased product.

In one embodiment, in block 245 a percentage of the purchase price or fixed fee is transferred to an account of the carrier 130 as a service fee, and transfers remaining finds to a host, which also receives a percentage of the purchase price or fixed fee as a service fee. The remaining funds are then transferred to the seller.

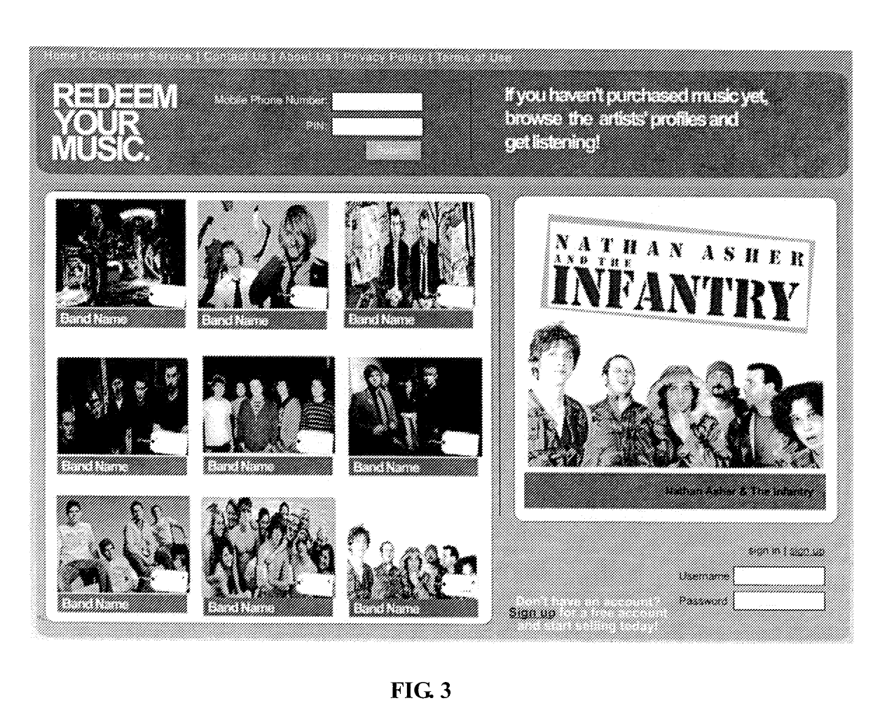

FIG. 3 illustrates a screen shot of a website where purchasers can redeem their purchased products. In one embodiment, musicians sign up with the host of the website and agree to their products purchase prices and the first and second percentages that will be deducted from the purchase price. A user can click on the musician's link and listen and or watch the product.

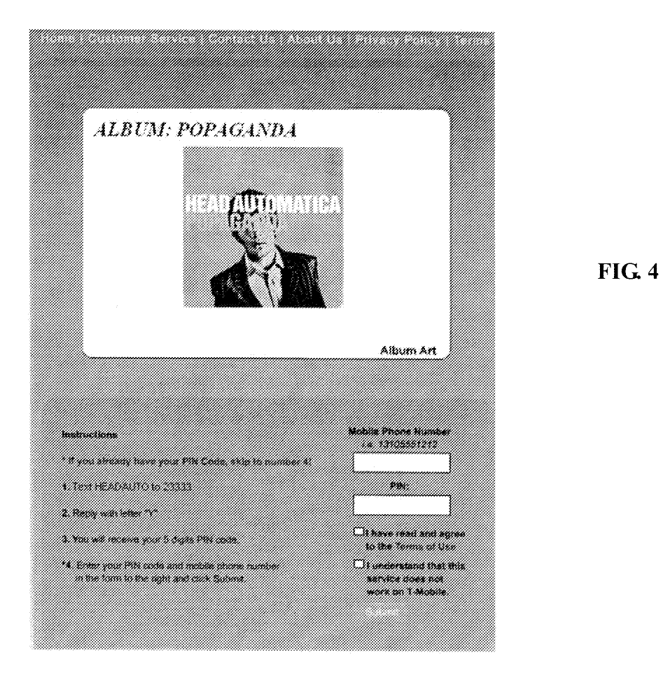

FIG. 4 illustrates a screen shot on the website of an artist's page. In this embodiment, a user that has received a code for purchasing the product can enter the code and then download their purchased product. In the sample screen shot, the assigned number to send a text message to is 23333 and the assigned keyword is HEADAUTO.

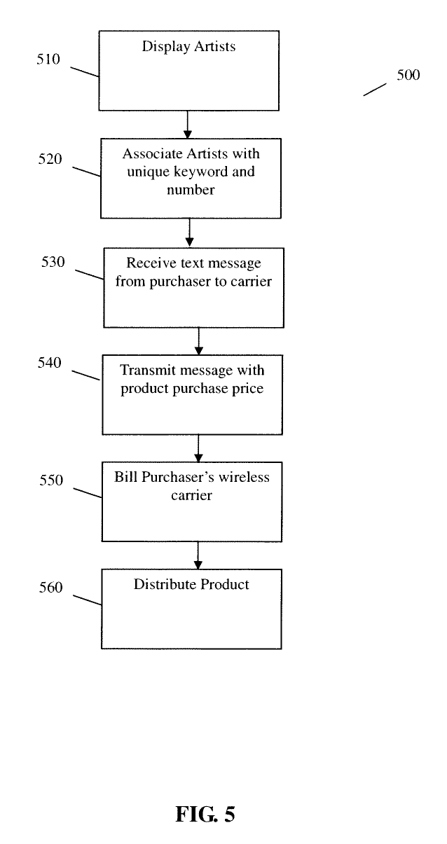

FIG. 5 illustrates a block diagram of a process 500. Process 500 begins with block 510 where artists are displayed on a website. In one embodiment, the artists can be entertainers (e.g., musicians, comedians, etc.). In block 520 the artists are associated with a unique keyword and text message number. In block 530 a purchaser of a product of the artists sends a text message to the number with the keyword, which is received from the purchaser's wireless carrier.

In block 540 the purchaser receives a text message with the product's purchase price and message requesting the user to accept or decline the purchase of the product associated with the keyword. Once the purchaser accepts the purchase, in block 550 the wireless carrier charges the purchase price to the purchaser's or customer's of the wireless carrier (e.g., in the case the purchaser is a child and the parent is the customer) wireless bill. Once the purchase is complete, the purchaser receives a text message with a code used for receiving the product. In block 560 the purchaser enters or has the code entered on an external device (such as a computer, kiosk, ATM, cash register, etc.) and the product is distributed.

In one embodiment, when the carrier receives payment for the purchase (i.e., the wireless service bill is paid), the cellular carrier receives a first percentage of the purchase price and transfers remaining funds to a host of a website. The host receives a second percentage of the purchase price and transfers remaining funds to a client, such as an artist.

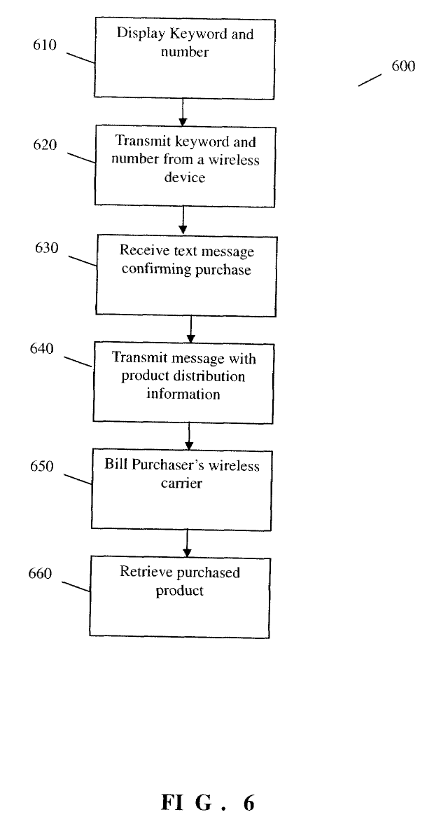

FIG. 6 illustrates a block diagram of an embodiment of process 600. Process 600 begins with block 610 where a keyword is displayed or announced. In block 620, the keyword is transmitted in a text message to a specific number from a wireless device. In block 630, when the purchaser accepts the purchase, the purchaser receives a text message confirming the purchase. In block 640 the carrier transmits a text message to the wireless device along with a code for allowing the product to be distributed to the purchaser. In block 650, the wireless carrier adds the purchase price to the customer's wireless bill. After the customer pays the wireless bill, the wireless carrier receives a first service fee and transfers the remaining funds to a host of a website. The host of the website receives a service fee and transfers remaining funds to the seller. In block 660 the purchaser uses the code to retrieve the purchased product.

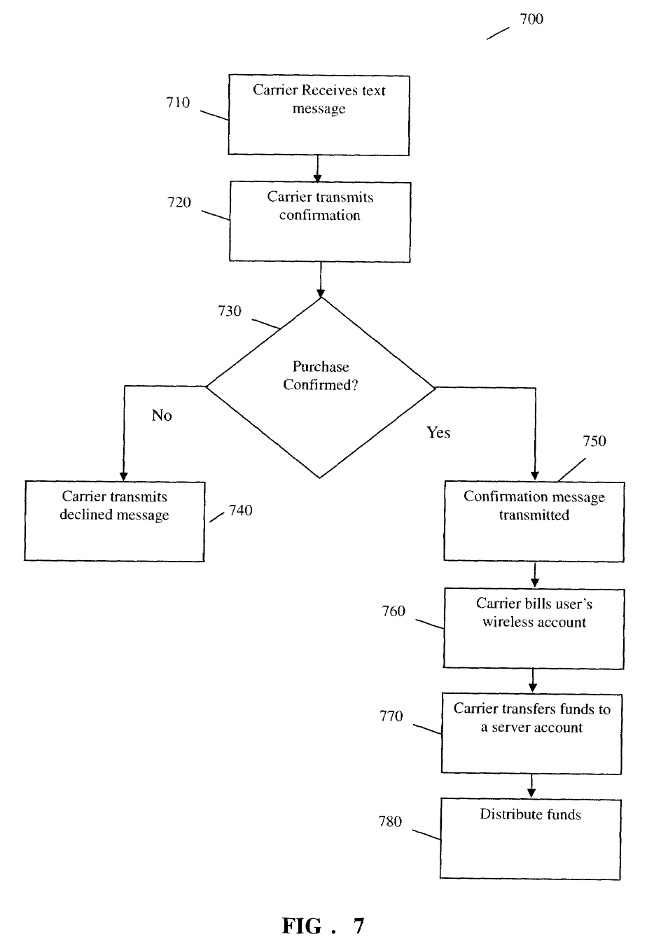

FIG. 7 illustrates a block diagram of another embodiment of a process 700. In block 710 a wireless carrier receives a text message including a keyword that is sent to a specific number from a wireless device. In block 720 the carrier transmits a text message to the wireless device requesting confirmation of a product that is associated with the keyword. In block 730 it is determined whether the purchase of the product is confirmed or not. If the carrier receives a decline message, in block 740 the carrier transmits a purchase declined message. If the purchase is confirmed, process 700 continues with block 750.

In block 750 a confirmation text message with a code is sent to the wireless device. In block 760 the wireless carrier bill's the user's or customer's wireless service account the purchase price of the product. In block 770 the wireless carrier transfers funds minus a service fee to a server account, such as a host of a website. In block 780 the server account keeps a service fee and distributes the remaining funds from the purchase to a seller.

In one embodiment the content/product/service to be purchased and/or downloaded is limited to a fixed number of purchases and/or downloads. In one embodiment, the percentage fee received by the owner/seller, host and wireless carrier is based on the number of purchases and/or downloads. Therefore, the percentages can be negotiated or have different percentages as the demand of the content/product/service increases. The wireless carrier and/or host can receive less of a percentage as the number of products increases. Many schemes can be negotiated for the terms of percentages, such as tiered percentages (e.g., a first fee for the first 500 content/product/service, a second fee for the next 501-2500, a third fee for the next 2501-7500, etc.). In one embodiment the host determines the percentages involved for the owner/seller and wireless carrier. In another embodiment, the owner/seller determines the percentages involved.

In one embodiment, a limitation on the number of purchases and/or downloads of contents/products/services can effect the price or value of the content/product/service based on supply and demand. This can also effect the resale of the content/product/service. In one embodiment, once all content/product/service have been sold, the purchasers can resell or auction the content/product/service on the website. In one embodiment, each download/purchase of contents/products/services are associated with a specific registration number, serial code, etc. For example, a limited content/product/service can be one of twenty/fifty/a hundred/etc. By limiting the amount of purchases and/or downloads the price/value of content/product/service can be maintained at a desired level. Also, the interest in purchasing contents/products/services can be increased causing quick sales.

With the above embodiments, users can purchase a variety of goods and services using a wireless account, such as a cellular telephone account. No special account needs to be created for the purchaser as the purchaser already has a wireless service account in place where the customer of the wireless service receives a bill (e.g., monthly cellular telephone bill). The user can conveniently purchase products without a debit card, credit card or bank account established. Additionally, if the wireless bill (including purchased products fees) is paid on time, the user is not charged any interest.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known circuits, structures and techniques have not been shown in detail to avoid obscuring the understanding of this description.

Embodiments of the present disclosure described herein may be implemented in circuitry, which includes hardwired circuitry, digital circuitry, analog circuitry, programmable circuitry, and so forth. These embodiments may also be implemented in computer programs. Such computer programs may be coded in a high level procedural or object oriented programming language. The program(s), however, can be implemented in assembly or machine language if desired. The language may be compiled or interpreted. Additionally, these techniques may be used in a wide variety of networking environments. Such computer programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the disclosure may also be considered to be implemented as a machine-readable or machine recordable storage medium, configured for use with a processing system, where the storage medium so configured causes the processing system to operate in a specific and predefined manner to perform the functions described herein.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
distributing a keyword;
receiving a text message from a device through a carrier with the keyword to purchase a product;
wherein the carrier adds a purchase price of the product to the purchaser's wireless service bill and the product is distributed to the purchaser external to the device.

2. The method of claim 1, further comprising:
associating one of a text message number and the keyword with a specific client selling the product.

3. The method of claim 1, further comprising:
associating the keyword with a product.

4. The method of claim 1, wherein the carrier receives a first percentage of the purchase price and transfers remaining funds to a host.

5. The method of claim 4, wherein the host receives a second percentage of the purchase price and transfers remaining funds to the client.

6. The method of claim 1, further comprising:
giving the purchaser an option to one of purchase the product and to decline purchasing the product.

7. The method of claim 1, further comprising:
transmitting instructions to the purchaser for receiving the product.

8. The method of claim 7, wherein the instructions contain a code.

9. The method of claim 8, wherein the code is a personal identification number (PIN).

10. The method of claim 1, wherein the purchaser downloads the product from a website.

11. The method of claim 1, wherein the purchaser retrieves the product from a business.

12. The method of claim 1, wherein the distributing the keyword is one of an announcement at an event, a display on a website, a display on an advertising medium, an announcement through audio, a display on video, printed on a product located at a business and displayed at a business.

13. The method of claim 1, wherein the product is one of a video content, an audio content, entrance to an event, and a combination of video content, audio content and the entrance to the event.

14. The method of claim 1, wherein the product is a physical product.

15. The method of claim 1, wherein the product is one of cash and cash back from the purchase.

16. The method of claim 1, wherein the product is a service.

17. A system comprising:
at least one server,
at least one carrier coupled to the at least one server,
wherein a text message with a specific keyword to purchase a product is received from a device through the at least one carrier, the at least one carrier adds a purchase price of the product to a purchaser's telephone bill and the product is distributed to the purchaser external to the device.

18. The system of claim 17, wherein the purchaser downloads the product from a website hosted on the at least one server.

19. The system of claim 17, wherein the at least one carrier receives a first percentage of the purchase price and transfers remaining funds to a host of the website.

20. The system of claim 19, wherein the host of the website receives a second percentage of the purchase price and transfers remaining funds to the seller of the product.

21. The system of claim 17, wherein the purchaser retrieves the product from a business.

22. The system of claim 17, wherein the product is one of a video content, an audio content, entrance to an event, and a combination of video content, audio content and the entrance to the event.

23. The system of claim 17, wherein the product is a physical product.

24. The system of claim 17, wherein the product is one of cash and cash back from the purchase.

25. The system of claim 17, wherein the product is a service.

26. A method comprising:
displaying a plurality of clients on a website; and
providing a product to a purchaser,
wherein the purchaser purchases the product by transmitting a text message from a device including a keyword, and a carrier of the purchaser adds a purchase price of the product to the purchaser's wireless service bill.
associating a plurality of products with unique keywords; and

27. The method of claim 26, wherein the cellular carrier receives a first percentage of the purchase price and transfers remaining funds to a host.

28. The method of claim 27, wherein the host receives a second percentage of the purchase price and transfers remaining funds to a client.

29. The method of claim 26, further comprising:
transmitting information to the purchaser for retrieving the product; and
retrieving the product using the information.

30. The method of claim 26, wherein the product is one of a video content, an audio content, entrance to an event, and a combination of video content, audio content and the entrance to the event.

31. The method of claim 26, wherein the product is a physical product.

32. The method of claim 26, wherein the keyword is one of announced by a person at an event, displayed on a website, displayed on an advertising medium, announced through audio, displayed on video, printed on a product located at a business and displayed at a business.

33. The method of claim 26, wherein the product is one of cash and cash back from the purchase.

34. The method of claim 26, wherein the product is a service.
